(19) United States
(12) Patent Application Publication
(10) Pub. No.: US 2026/0175964 A1
(43) Pub. Date: Jun. 25, 2026

(54) AIRCRAFT HIGH-LIFT DEVICE

(71) Applicant: Airbus Operations, S.L.U., Madrid (ES)

(72) Inventor: María MURUZABAL SOPELANA, Getafe (ES)

(21) Appl. No.: 19/423,453

(22) Filed: Dec. 17, 2025

(30) Foreign Application Priority Data
Dec. 19, 2024 (EP) 24383417.3

(51) Int. Cl. B64C 3/48

(52) U.S. Cl. CPC B64C 3/48

(57) ABSTRACT

Aircraft high-lift device (1) of a lifting surface (2) including an upper skin (3), lower skin (4) and a nose (5), the high-lift device (1) includes: a flexible skin allowing for a morphing high-lift device (1), having a rear upper edge (7.1) and a rear lower edge (7.2), at least the rear upper edge (7.1) sliding along the chordwise direction between a retracted position and an extended position, and a linear actuator (6) connected to the nose (5) and pivotably connected to the lifting surface (2) between the retracted position and the extended position, so that in the extended position the nose (5) is located in a downward location with respect to its location in the retracted position and at least the rear upper edge (7.1) is located in an anterior location with respect to its location in the retracted position.

### RELATED APPLICATION

This application incorporates by reference and claims priority to European Patent application 28343817, filed Dec. 19, 2024.

### FIELD OF THE INVENTION

The present invention relates to the field of movable high-lift devices in aircraft. More specifically, it relates to leading edge slats and flaps.

### BACKGROUND

A high-lift device is a component or mechanism on an aircraft's lifting surface, for instance a wing, that increases the amount of lift produced by said lifting surface. A lifting surface is any three-dimensional body whose primary purpose is to generate aerodynamic lift. Both, the high-lift device and the lifting surface have a spanwise direction and a chordwise direction. The spanwise direction is the direction from root to tip of the lifting surface. The chordwise direction is the imaginary straight line joining the leading edge and trailing edge of the airfoil.

The size and lifting capacity of a lifting surface is chosen as a compromise between differing requirements. For example, a larger wing will provide more lift and will reduce the distance and speeds required for take-off and landing, but it will increase drag, which reduces performance during the cruising portion of flight. Aircraft lifting surface designs are optimized for speed and efficiency during the cruise portion of flight, since this is where the aircraft spends the vast majority of its flight time. High-lift devices compensate for this design trade-off by adding lift at take-off and landing, reducing the speed and distance required to safely land the aircraft, and allowing the use of a more efficient lifting surface in flight.

Lifting devices are exposed to bird strike damage, among other damages, and have to be easily repairable or interchangeable, so a light, strong and easy to assemble component is sought.

The materials chosen for the structure of the high-lift device are selected to ensure a minimum weight design while retaining the ability to repair damage-prone surfaces. Aluminum alloy is typically used.

Slats are known as high-lift devices located on the leading edge of, for instance, wings of the aircraft. As previously stated, their purpose is to increase lift during low speed operations, such as take-off, initial climb, approach and landing. Slats are actuated in order to increase the wing area and camber during low speed operation of the aircraft. This allows the aircraft to fly at lower speeds and take off and land in a shorter distance.

Two main types of slats are known: fixed and movable. Fixed slats are permanently attached to the lifting surface and remain in a fixed position during flight. Movable slats are able to move outwards in order to increase the lift during low speed operations and to retract during cruise, reducing drag.

In a conventional configuration, the slat kinematics is driven by joints and supported by tracks. Each track is moveable on the wing structure between a fully extended position and a stowed position. In the retracted position the slat track is housed in a track can, mounted on the inner face of the wing front spar.

The main disadvantages of the above movable high-lift device configuration are:
There is a gap between the high-lift device and the lifting surface leading edge that increases the drag during cruise conditions. Said gap is even increased when the high-lift device is extended as there is a discontinuity in the upper surface of the leading edge. In addition, the aforementioned gap generates considerable noise.

On a wing, the tracks enter into the fuel tank area, thus they need to be housed in the lifting surface front spar. This housing affects the torsion box, which is a primary structure of the lifting surface, and it requires a reinforcement of the spar due to this discontinuity.

Morphing technology is also known to be applied to the leading edge of a lifting surface. Morphing is used in order to achieve a flexible large-displacement leading edge. It is also known as a droop nose.

Morphing allows a part of the structure, for instance, the nose to change shape during take-off and landing so that there is no need for separate slats, and therefore, no gap exists, decreasing the drag associated.

Morphing structures also have some disadvantages such as: the total chordwise length of the lifting surface is not modified, only the leading edge angle, decreasing the lift generated, and an elastic material is needed to deform the nose, which requires internal reinforcements and structures to maintain the desired shape.

### SUMMARY

The invention disclosed herein may be embodied as an aircraft high-lift device of a lifting surface.

The high-lift device comprises a skin, i.e., the outer surface covering that provides an aerodynamic shape. Said skin comprises an upper skin, a lower skin and a nose. The upper skin is the portion of the skin located on the suction surface or ‘extrados’ of the high-lift aerofoil. The lower skin is the portion of the skin located on the pressure surface or ‘intrados’. The nose corresponds with the leading-edge shape of the high-lift device.

The high-lift device may include:
A flexible skin configured to allow for a morphing high-lift device. Thus, the skin is of the kind that is capable of bending continuously without breaking. A morphing structure is one that can adaptively regulate its aerodynamic layout to meet the demands of varying flight conditions. The flexible skin has a rear upper edge and a rear lower edge. The rear edge is the edge of the skin furthest away from the nose. At least the rear upper edge is configured to slide along the chordwise direction between a retracted position and an extended position. Thus, the rear upper edge is movable in the chordwise direction. The extended position is the position in which the camber and the lift are increased. The retracted position is the position that implies drawing back from the extended position.

A linear actuator connected to the nose and configured to be pivotably connected to the lifting surface between the retracted position and the extended position. In the extended position, the linear actuator is configured so that the nose is located in a downward location with respect to its location the retracted position. And also at least the rear upper edge is configured to be located in an anterior location with respect to its location in the retracted position to increase the lift of the lifting surface. Anterior is understood as in a leading position with respect to the chordwise direction. According to the above, the linear actuator is connected, or in other words, linked together in some way, either directly or through an intermediate connector, to the nose and to the lifting surface.

The linear actuator comprises an anterior end and a posterior end. In an embodiment, the anterior end is connected to the nose. The posterior end is configured to be connected to the lifting surface. The linear actuator is located within the flexible skin.

According to the above, the linear actuator is configured to be: extendable along the linear axis of the linear actuator, therefore it can be made longer or shorter, and/or pivotable with respect to the lifting surface. In an embodiment it is pivotable with respect to the posterior end of the linear actuator around an axis located in the spanwise direction passing through this posterior end. The linear actuator is pivotable between a retracted position and an extended position. In the retracted position the linear actuator is located in an upper position, corresponding to a cruise position. In the extended position the nose is located in a downward position with respect to the retracted position and at least the rear upper edge is configured to be movable towards an anterior position with respect to its retracted position to increase the lift of the lifting surface.

Upper and downward are referenced with respect to the ground.

According to the above, the invention may be embodied to provide an alternative for the known high-lift devices. It uses a combination of morphing technology in order to maintain the aerodynamic surface's continuity and extendable elements in order to increase the chordal length to reduce drag when the high-lift devices are extended. The claimed invention leads to a decrease in fuel consumption and an increase in efficiency of the aircraft.

In an embodiment, the flexible skin extends continuously between the rear upper edge and the rear lower edge. At least the rear upper edge is free to slide along the chordwise direction. Its movement is not restricted in the chordwise direction, for instance, by being mechanically joined to the skin of the lifting surface. According to the above, said edges are slidable with respect to the skin of the lifting surface. The upper skin is partly sheltered into the lifting surface at its rear part, and it will slide out when the high-lift device is extended, increasing the lifting surface area.

As previously stated, the linear actuator is connected to the nose. When the actuator extends, the upper skin slides forward, and the high-lift device will deform into a droop nose shape.

According to the above, the invention may be used to overcome some or all of the disadvantages of known high-lift devices.

The combination between the morphing structure and the slidable rear upper edge reduces the gap between the high-lift device and the lifting surface and avoids the need of tracks inside the lifting surface. Therefore, the gap is minimized, and the drag and noise are reduced.

The slidable rear upper edge end allows a sliding upper surface which enables the high-lift device to increase the leading edge surface. As the upper surface of the high-lift device is not fixed and can slide out of the leading edge of the lifting surface, the whole lifting surface can be modified, increasing the lift generation.

The assembly of the high-lift device is simple, with a reduced number of internal elements, and easy to change or repair, reducing maintainability costs.

The high-lift device claimed device may have reduced weight because it does not need actuators or guides.

The invention may be embodied as a lifting surface comprising an aircraft high-lift device and aircraft comprising a lifting surface.

### DESCRIPTION OF THE FIGURES

To complete the description and to provide for a better understanding of the invention, drawings are provided. Said drawings form an integral part of the description and illustrate preferred embodiments of the invention. The drawings comprise the following figures.

FIGS. 1a and 1b show a schematic lateral representation of a portion of the lifting surface and an embodiment of the high-lift device in a retracted position, FIG. 1a, and in a extended position, FIG. 1b.

FIG. 2 shows a schematic lateral representation of an embodiment of the high-lift device rear upper edge and a portion of the skin of the annexed lifting surface in a retracted position and in an extended position.

FIG. 3 shows a schematic lateral representation and a perspective representation of an embodiment of the rear upper edge and a portion of the skin of the annexed lifting surface.

FIG. 4 shows a lateral view of a lifting surface and of a high-lift device according to an embodiment of the invention.

FIG. 5 shows a lateral view of an aircraft.

### DETAILED DESCRIPTION

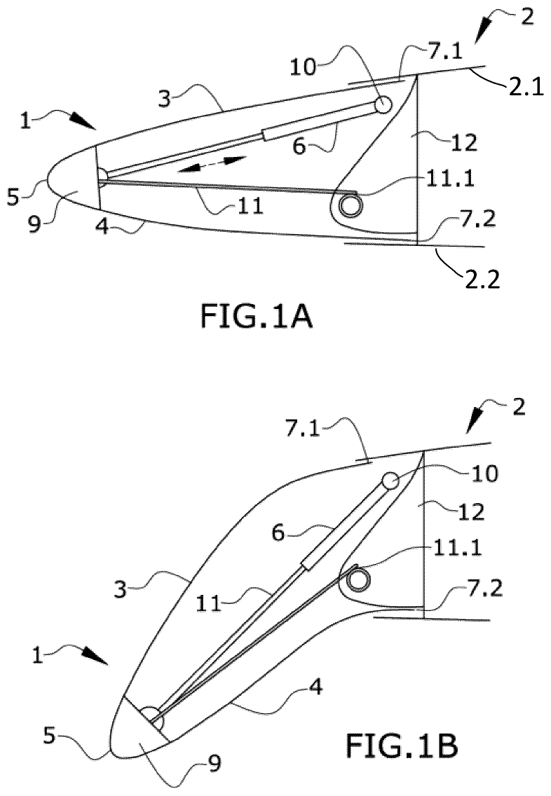

FIGS. 1a and 1b show a schematic lateral representation of an embodiment of the high-lift device (1) in a retracted position, FIG. 1a, and in an extended position, FIG. 1b, and it also shows a portion of the annexed lifting surface (2). The lifting surface (2) may be a fixed wing, e.g., a wing box, that includes an upper skin (2.1) and a lower skin (2.2).

The aircraft high-lift device (1) comprises a skin comprising an upper skin (3), a lower skin (4) and a nose (5). The skin (3) has a rear upper edge (7.1) and a rear lower edge (7.2). At least the rear upper edge (7.1) being configured to slide along the chordwise direction between a retracted position and an extended position, so that it can freely slide with respect to the lifting surface (2).

The skin (3) is a flexible skin configured to allow a morphing high-lift device (1). The flexible skin (3) can be manufactured from aluminum or composite material.

The high-lift device (1) also comprises a linear actuator (6) having an anterior end and a posterior end (10). The anterior end is connected to the nose (5). The posterior end (10) is connected to the lifting surface (2).

The linear actuator (6) is extendable along its linear axis. It is pivotable with respect to the lifting surface (2). In an embodiment, it is pivotable with respect to the posterior end (10) around an axis in the spanwise direction. The linear actuator (6) is movable between a retracted position and an extended position. In the retracted position the linear actuator (6) is located in an upper position. In the extended position the linear actuator (6) is extended and its nose (5) is located in a downward position with respect to its location in the retracted position. The rear upper edge (7.1) is moved towards an anterior position with respect to its location in the retracted position so that the lift of the lifting surface (2) is increased.

In the shown embodiment, the high-lift device (1) comprises a rib (9) located in the nose (5) in a chordwise direction. The rib (9) helps to impart the required shape to the high-lift device (1) nose (5) as the skin adopts the rib (9) shape when stretched over it. The rib (9) maintains the shape of the leading edge with minimal internal structure so that the high-lift device (1) requires less internal reinforcement, and it reduces the weight and cost of the claimed invention. The rib (9) allows to reduce the number of reinforcements in order to maintain the high-lift device (1) shape, using only the small rib (9) reinforcement. The rib (9) has a longitudinal direction, its longitudinal direction coincides with the chordwise direction.

In the shown embodiment, the anterior end of the linear actuator (6) is joined to the rib (9). Thus, they are directly attached.

In the embodiment shown in FIG. 1, the high-lift device (1) in addition comprises a rod (11) connected to the nose (5) and configured to be pivotably connected to the lifting surface (2).

The rod (11) has an anterior end connected to the nose (5) and a posterior end (11.1) connected to the lifting surface (2). In an embodiment, the rod (11) is pivotable with respect to the posterior end (11.1) around an axis in the spanwise direction between the retracted position and the extended position. The rod (11) would act as a guide for the upper skin (3) in collaboration with the linear actuator (6) to go back to its initial position when the retraction is performed.

In the shown embodiment, the anterior end of the rod (11) is joined to the nose rib (9).

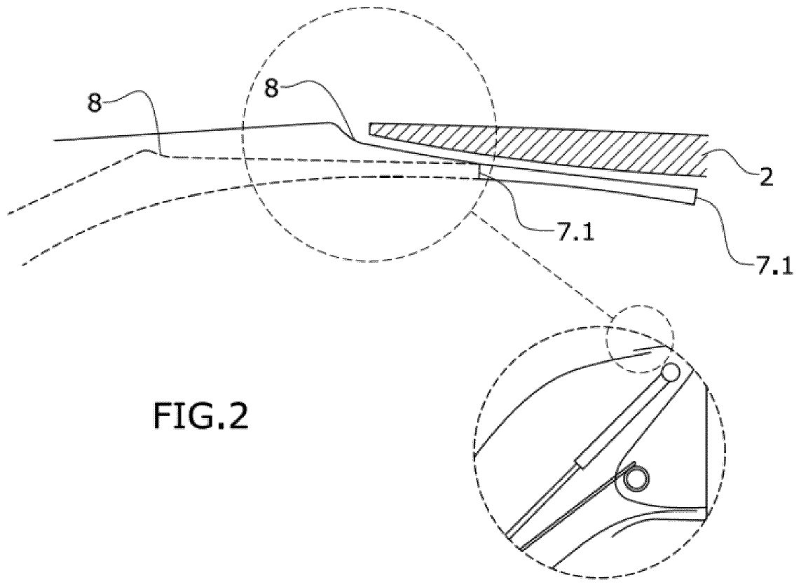

FIG. 1 and, more specifically, FIG. 2 show the upper skin (3) comprising a step (8), a discontinuity in the thickness or depth of the upper skin (3), in the chordwise direction. The step (8) being configured to be annexed to a forward end of the skin of the lifting surface (2) in the retracted position so that the skin of the high-lift device (1) and the skin of the lifting surface (2) are flush, i.e., having or forming a continuous plane or unbroken surface. Thus, there is no gap in height between the high-lift device (1) and the lifting surface (2). The step (8) allows the upper skin (3) to be at least partly located under the lifting surface (2) in the retracted position. Under the lifting surface (2) is understood considering a reference with respect to the ground in an operating position.

In addition, the area of the upper skin (3) between the step (8) and the rear upper edge (7.1) in the chordwise direction is tapered. It helps to decrease gaps between the high-lift device (1) and the lifting surface (2). It also smooths the sliding movement of the upper skin (3).

Moreover, in an embodiment both interface surfaces, of the high-lift device (1) and of the lifting surface (2) are tapered in order to maintain the smallest step possible when the high-lift device (1) is extended.

The lower skin (4) can be fixed or use the same solution as the upper skin (3). Thus, in an embodiment, the lower skin (4) comprises a step in the chordwise direction. The step is configured to be annexed to a forward end of the skin of the lifting surface (2) in the retracted position so that the skin of the high-lift device (1) and the skin of the lifting surface (2) are flush. In addition, the rear edge area between the step and the rear edge is configured to be at least partly located, with respect to the surrounding airflow, under the lifting surface (2) in the retracted position and in the extended position so that there is no gap in the chordwise direction between the high-lift device (1) the lifting surface (2).

According to the above, the rear upper edge (7.1) of the high-lift device (1) is configured to slide along the chordwise direction with respect to the lifting surface (2) between a retracted position and an extended position. More specifically, the rear upper edge (7.1) is configured to be movable towards an anterior position with respect to the lifting surface (2). More particularly, the rear upper edge (7.1) is configured to be located under the lifting surface skin (2) both in the retracted position and in the extended position.

In the shown embodiment, the lifting surface (2) comprises a spar (12) located in the spanwise direction annexed, i.e., in proximity to the high-lift device (1). In an embodiment, this spar (12) is the front spar of the lifting surface (2).

In the shown embodiment, the linear actuator (6) is pivotably joined to the spar (12). More specifically, the linear actuator (6) is located on the upper area of the spar (12).

In addition, the rod (11) is pivotably joined to the spar (12). The rod (12) is located on the lower area of the spar (12). Thus, the linear actuator (6) and the rod (11) are joined to different heights to the lifting surface (2), more specifically, to the spar (12). It promotes rotation of the nose (5).

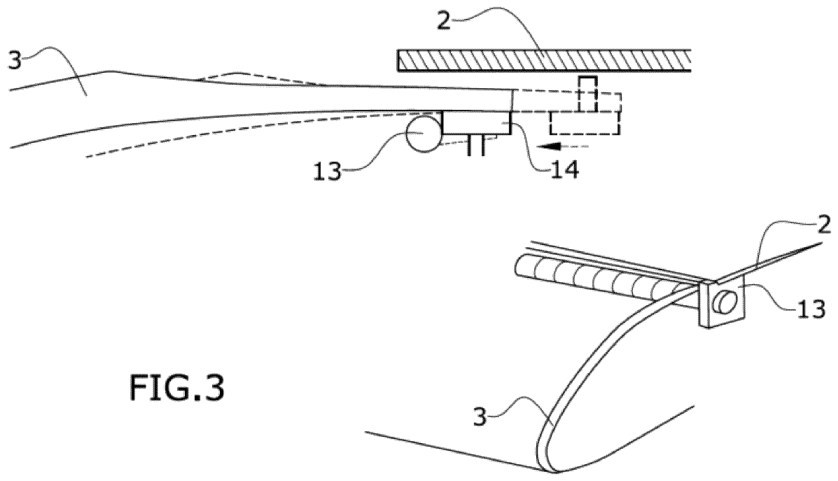

FIG. 3 shows that the lifting surface (2) and the high-lift device (1) comprise a stopper assembly. The upper skin (3) comprises at its rear upper edge (7.1) a protrusion (14) and the lifting surface (2) comprises a retainer (13). The retainer (13) and the protrusion (14) are configured to contact each other to prevent the upper skin (3) from slipping off the lifting surface (2) in the chordwise direction in the extended position. Therefore, in order to prevent the upper skin (3) from stepping out of the lifting surface (2), a mechanical stopper is located. In an embodiment, it may consist of a bar fixed to the lifting surface (2) as a retainer (13) and a protrusion (14) located on the edges of the high-lift device (1) along the whole span.

In the shown embodiment, the protrusion (14) and the retainer (13) are configured to be located under the lifting surface (2) skin with respect to the surrounding airflow both in the retracted position and in the extended position.

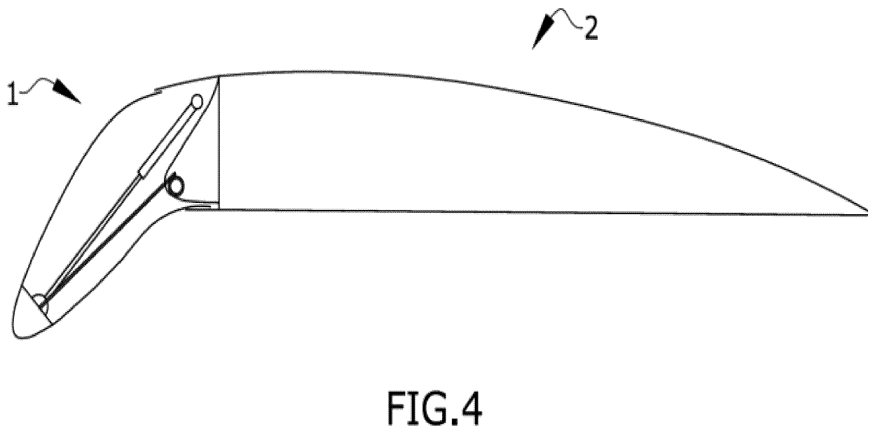

FIG. 4 shows a lateral view of a lifting surface comprising a high-lift device (1) according to the above described.

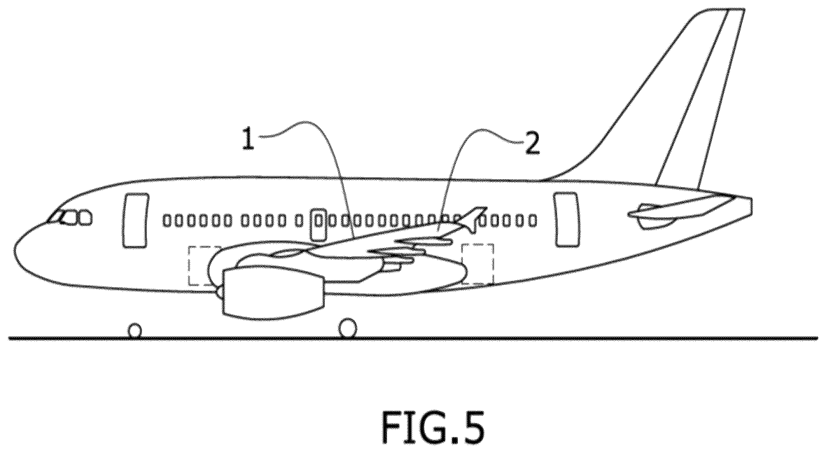

FIG. 5 shows a lateral view of an aircraft comprising a lifting surface according to the above described.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft high-lift device coupled to a lifting surface of an aircraft, the high-lift device has a chordwise direction and a spanwise direction, the high-lift device includes:
an upper skin including a flexible skin having a shape which morphs as the high-lift device moves between a retracted position and an extended position related to the lifting surface;
a lower skin including a flexible skin having a shape which morphs as the high-lift device moves between the retracted position and the extended position;
a nose forward of and attached to the upper skin and the lower skin,
a linear actuator between the upper skin and the lower skin, and connected to the nose, wherein the linear actuator is configured to be pivotably connected to the lifting surface and move the high-lift device between the retracted position and the extended position,
wherein the upper skin includes a rear upper section extending in the chordwise direction which is adjacent the lifting surface and is configured to slide along the lifting surface in the chordwise direction as the high-lift devices moves between the retracted position and the extended position,
wherein the lower skin includes a rear lower section extending in the chordwise direction which is adjacent the lifting surface and the rear lower section is configured to slide along the lifting surface in the chordwise direction as the high-lift devices moves between the retracted position and the extended position,
wherein, while the high-lift device is in the extended position, the nose is in a downward position relative to a position of the nose while the high-lift device is in the retracted position, and
wherein at least the rear upper section advances in the chordwise direction as the high-lift device moves from the retracted position to the extended position to increase lift generated by the lifting surface and the high-lift device.

2. The aircraft high-lift device according to claim 1, wherein the linear actuator comprises a forward end and a rear end, and the rear end is pivotable connected to the lifting surface and pivots about an axis extending in the spanwise direction.

3. The aircraft high-lift device according to claim 1, further including a rib in the nose and extending in the chordwise direction.

4. The aircraft high-lift device according to claim 3, wherein the linear actuator is connected to the rib.

5. The aircraft high-lift device according to claim 1, further including a rod connected to the nose, extending to the lifting surface and pivotably connected to the lifting surface.

6. The aircraft high-lift device according to claim 5, wherein the rod is connected to a rib in the nose, and the rib extends in the chordwise direction.

7. The aircraft high-lift device according to claim 1, wherein the upper skin includes a step extending in the chordwise direction, wherein the step is configured to be connected to a forward portion of the skin of the lifting surface such that the skin of the high-lift device is flush with the skin of the lifting surface while the high-lift device is in the retracted position.

8. The aircraft high-lift device according to claim 7, wherein the upper skin includes an area between the step and the rear upper section, and the area is tapered in the chordwise direction.

9. The aircraft high-lift device according to claim 7, wherein the lower skin includes a step extending in the chordwise direction, and the step is annexed to a forward end of the skin of the lifting surface in the retracted position so that the skin of the high-lift device and the skin of the lifting surface are flush.

10. A wing of an aircraft including:
a fixed wing including a first upper skin having a forward upper edge and a first lower skin with a forward lower edge, and
a high-lift device including:
a second upper skin including a flexible skin having a shape which morphs as the high-lift device moves between a retracted position and an extended position relative to the fixed wing;
a second lower skin which includes a flexible skin having a shape which morphs as the high-lift device moves between the retracted position and the extended position;
a nose forward of and attached to the second upper skin and the second lower skin of the high-lift device,
a linear actuator between the second upper skin and the second lower skin, and the linear actuator includes a first end region connected to the nose and a second end region pivotably connected to the fixed wing, wherein the linear actuator moves the high-lift device between the retracted position and the extended position,
wherein the first upper skin includes a rear upper section which is adjacent the lifting surface and is configured to slide along the lifting surface in the chordwise direction as the high-lift device moves between the retracted position and the extended position,
wherein the lower skin includes a rear lower section which is adjacent the lifting surface and is configured to slide along the lifting surface in the chordwise direction as the high-lift device moves between the retracted position and the extended position,
wherein, while the high-lift device is in the extended position, the nose is in a downward position relative to the lifting surface relative to a potion of the nose while the high-lift device is in the retracted position,
wherein the rear upper section and the rear lower section advance in the chordwise direction as the high-lift device moves from the retracted position to the extended position, and
wherein the rear upper edge is configured to slide in the chordwise direction against and remain in contact with the fixed wing as the high-lift device moves between the retracted position and the extended position.

11. The wing according to claim 10, wherein the rear upper edge of the high-lift device is overlapped by and in sliding contact with the first upper skin of the fixed wing skin while the high-lift device is in the extended position, and
wherein the rear lower edge of the high-lift device overlaps and is in sliding contact with the first lower skin of the fixed wing while the high-lift device is in the extended position.

12. The wing according to claim 10, further including a spar oriented in the spanwise direction and, wherein the linear actuator is pivotably joined to the spar.

13. The wing according to claim 12, further comprising a rod including a first end pivotably connected to the nose and a second end pivotably connected to the spar at a position on the spar spaced vertically from a position on the spar to which the linear actuator is pivotably joined.

14. The wing according to claim 10, wherein the second upper includes a rear upper edge region with a protrusion,
wherein the fixed wing includes a retainer, and
wherein the retainer contacts the protrusion to prevent the second upper skin from separating from the fixed wing as the high-lift device moves into the extended position.

15. An aircraft including the wing according to claim 10.
